(19) United States
(12) Patent Application Publication
(10) Pub. No.: US 2025/0324241 A1
(43) Pub. Date: Oct. 16, 2025

(54) SIGNAL FORWARDING USING ONE OR MORE COEFFICIENTS

(71) Applicant: QUALCOMM Incorporated, San Diego, CA (US)

(72) Inventors: Ahmed ELSHAFIE, San Diego, CA (US); Seyedkianoush HOSSEINI, San Diego, CA (US); Yuchul KIM, San Diego, CA (US); Zhikun WU, Beijing (CN); Linhai HE, San Diego, CA (US); Huilin XU, Temecula, CA (US)

(21) Appl. No.: 18/867,999

(22) PCT Filed: Jul. 18, 2022
(86) PCT No.: PCT/CN2022/106173

§ 371 Date: Nov. 21, 2024

(51) Int. Cl. H04W 8/24; H04B 7/06; H04W 52/02

(52) U.S. Cl. CPC H04W 8/24; H04B 7/0617; H04W 52/0209

(57) ABSTRACT

Various aspects of the present disclosure generally relate to wireless communication. In some aspects, an Internet-of-Things (IoT) device may transmit signal forwarding capability information indicating one or more capabilities relating to signal forwarding using one or more coefficients for beamforming. The IoT device may communicate in accordance with the signal forwarding capability information. Numerous other aspects are described.

### FIELD OF THE DISCLOSURE

Aspects of the present disclosure generally relate to wireless communication and to techniques and apparatuses for signal forwarding using one or more coefficients.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by an apparatus of an Internet-of-Things (IoT) device. The method may include transmitting signal forwarding capability information indicating one or more capabilities relating to signal forwarding using one or more coefficients for beamforming. The method may include communicating in accordance with the signal forwarding capability information.

Some aspects described herein relate to a method of wireless communication performed by an apparatus of a network node. The method may include receiving signal forwarding capability information indicating one or more capabilities of one or more IoT devices relating to signal forwarding using one or more coefficients for beamforming. The method may include communicating in accordance with the signal forwarding capability information.

Some aspects described herein relate to a method of wireless communication performed by an apparatus of user equipment (UE). The method may include receiving configuration information indicating at least one reference signal set relating to signal forwarding, by one or more IoT devices, using one or more coefficients for beamforming. The method may include receiving reference signals of the at least one reference signal set.

Some aspects described herein relate to an apparatus for wireless communication at an IoT device. The apparatus may include a memory and one or more processors coupled to the memory. The one or more processors may be configured to transmit signal forwarding capability information indicating one or more capabilities relating to signal forwarding using one or more coefficients for beamforming. The one or more processors may be configured to communicate in accordance with the signal forwarding capability information.

Some aspects described herein relate to an apparatus for wireless communication at a network node. The apparatus may include a memory and one or more processors coupled to the memory. The one or more processors may be configured to receive signal forwarding capability information indicating one or more capabilities of one or more IoT devices relating to signal forwarding using one or more coefficients for beamforming. The one or more processors may be configured to communicate in accordance with the signal forwarding capability information.

Some aspects described herein relate to an apparatus for wireless communication at a UE. The apparatus may include a memory and one or more processors coupled to the memory. The one or more processors may be configured to receive configuration information indicating at least one reference signal set relating to signal forwarding, by one or more IoT devices, using one or more coefficients for beamforming. The one or more processors may be configured to receive reference signals of the at least one reference signal set.

Some aspects described herein relate to a non-transitory computer-readable medium that stores a set of instructions for wireless communication by an IoT device. The set of instructions, when executed by one or more processors of the IoT device, may cause the IoT device to transmit signal forwarding capability information indicating one or more capabilities relating to signal forwarding using one or more coefficients for beamforming. The set of instructions, when executed by one or more processors of the IoT device, may cause the IoT device to communicate in accordance with the signal forwarding capability information.

Some aspects described herein relate to a non-transitory computer-readable medium that stores a set of instructions for wireless communication by a network node. The set of instructions, when executed by one or more processors of the network node, may cause the network node to receive signal forwarding capability information indicating one or more capabilities of one or more IoT devices relating to signal forwarding using one or more coefficients for beamforming. The set of instructions, when executed by one or more processors of the network node, may cause the network node to communicate in accordance with the signal forwarding capability information.

Some aspects described herein relate to a non-transitory computer-readable medium that stores a set of instructions for wireless communication by a UE. The set of instructions, when executed by one or more processors of the UE, may cause the UE to receive configuration information indicating at least one reference signal set relating to signal forwarding, by one or more IoT devices, using one or more coefficients for beamforming. The set of instructions, when executed by one or more processors of the UE, may cause the UE to receive reference signals of the at least one reference signal set.

Some aspects described herein relate to an apparatus for wireless communication. The apparatus may include means for transmitting signal forwarding capability information indicating one or more capabilities relating to signal forwarding using one or more coefficients for beamforming. The apparatus may include means for communicating in accordance with the signal forwarding capability information.

Some aspects described herein relate to an apparatus for wireless communication. The apparatus may include means for receiving signal forwarding capability information indicating one or more capabilities of one or more IoT devices relating to signal forwarding using one or more coefficients for beamforming. The apparatus may include means for communicating in accordance with the signal forwarding capability information.

Some aspects described herein relate to an apparatus for wireless communication. The apparatus may include means for receiving configuration information indicating at least one reference signal set relating to signal forwarding, by one or more IoT devices, using one or more coefficients for beamforming. The apparatus may include means for receiving reference signals of the at least one reference signal set.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of backscatter communication, in accordance with the present disclosure.

FIG. 5 is a diagram illustrating an example of communication using distributed antennas, in accordance with the present disclosure.

FIGS. 6A-6G are diagrams illustrating examples associated with signal forwarding using one or more coefficients, in accordance with the present disclosure.

FIGS. 7-9 are diagrams illustrating example processes associated with signal forwarding using one or more coefficients, in accordance with the present disclosure.

FIGS. 10-12 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

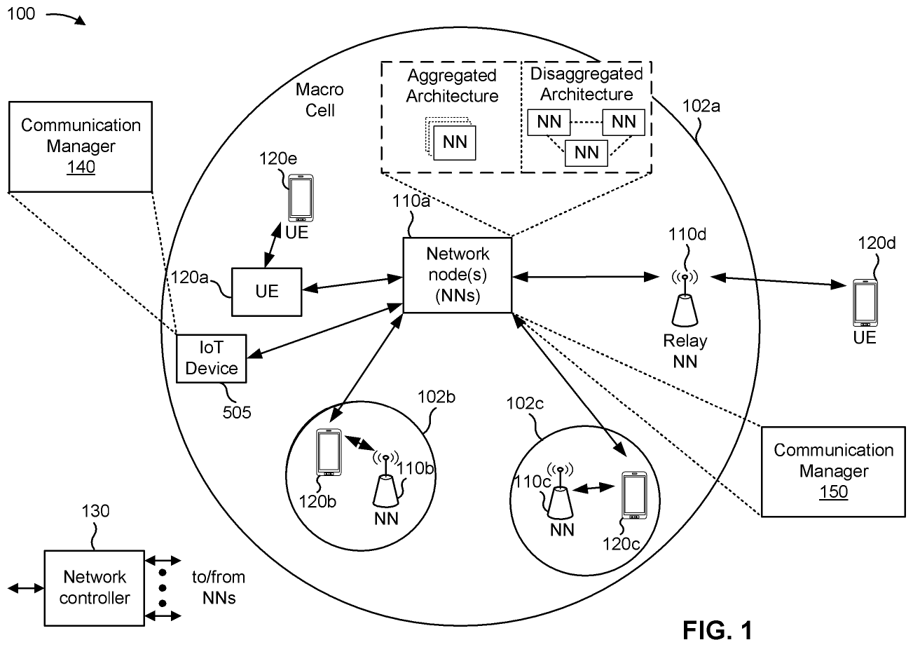

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5GNR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

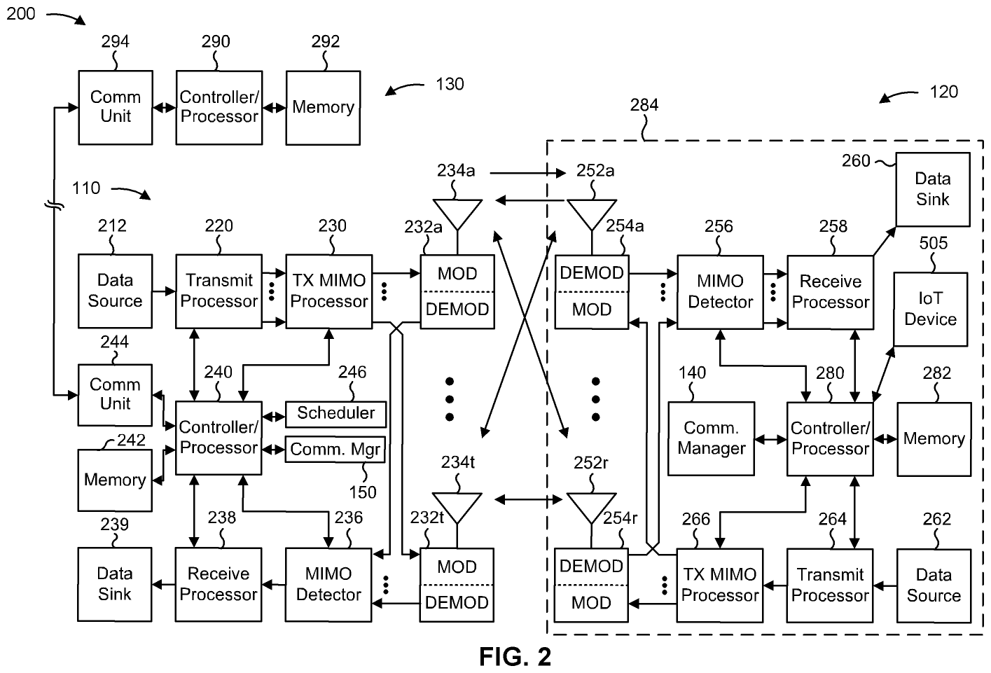

In some aspects, the network 100 may include IoT device(s) 505. IoT device(s) 505 can include a passive RF identification (RFID) tag, a semi-passive RFID tag, an active RFID tag, and/or the like, or a UE 120 that is using an RFID tag, as discussed with reference to FIG. 2. Some IoT devices are referred to as passive IoT devices. The IoT device(s) 505 can be capable of serving as a distributed antenna system to enable beamforming to one or more UEs. IoT devices may enable beamforming by backscattering or reflecting signals from/to network node 110 and/or from/to UE 120. IoT device(s) 505 may or may not be capable of boosting the power of the backscattered and/or reflected signal, and as such, it may be useful for the network 100 and/or network node 110 to be aware of signal forwarding capability information of the IoT device(s) 505, including a capability of boosting backscattered and/or reflected signals and other signal forwarding capabilities as described further below. IoT device(s) 505 may include a communication manager 140. As described in more detail elsewhere herein, the communication manager 140 may transmit signal forwarding capability information indicating one or more capabilities relating to signal forwarding using one or more coefficients; and communicate in accordance with the signal forwarding capability information. As described in more detail elsewhere herein, the communication manager 140 may receive configuration information indicating at least one reference signal set relating to signal forwarding using one or more coefficients; and receive reference signals of the at least one reference signal set. Additionally, or alternatively, the communication manager 140 may perform one or more other operations described herein.

In some aspects, the network node may include a communication manager 150. As described in more detail elsewhere herein, the communication manager 150 may receive signal forwarding capability information indicating one or more capabilities of a UE relating to signal forwarding using a coefficient; and communicate in accordance with the signal forwarding capability information. Additionally, or alternatively, the communication manager 150 may perform one or more other operations described herein.

As indicated above, FIG. 1 is provided as an example. Other examples may differ from what is described with regard to FIG. 1.

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T>1). The UE 120 may be equipped with a set of antennas 252a through 252r, such as R antennas (R>1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

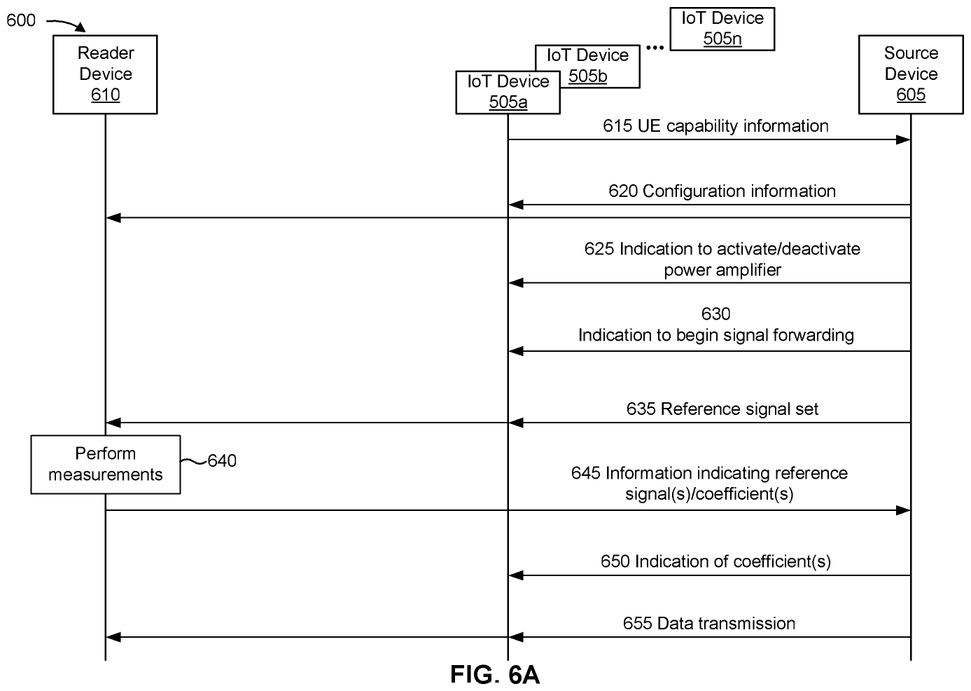

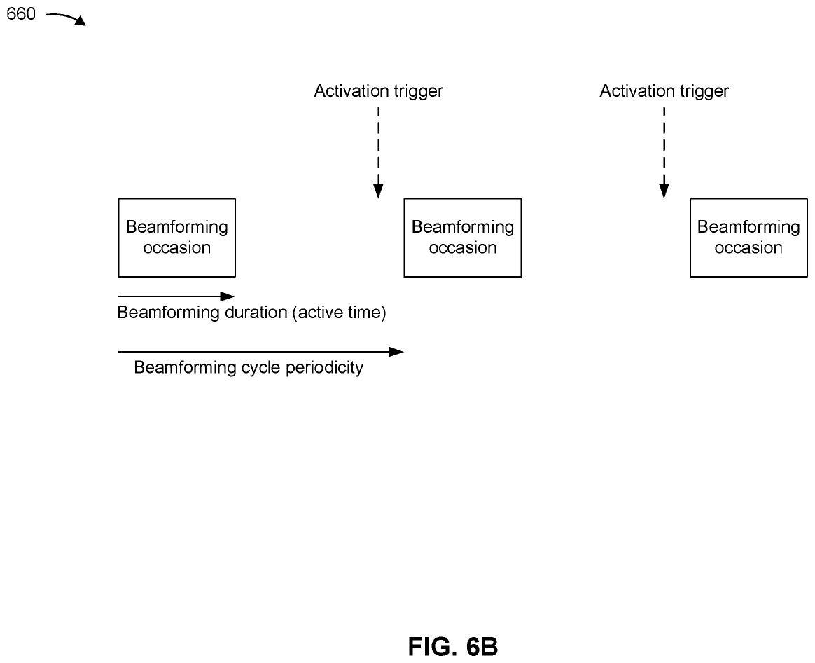

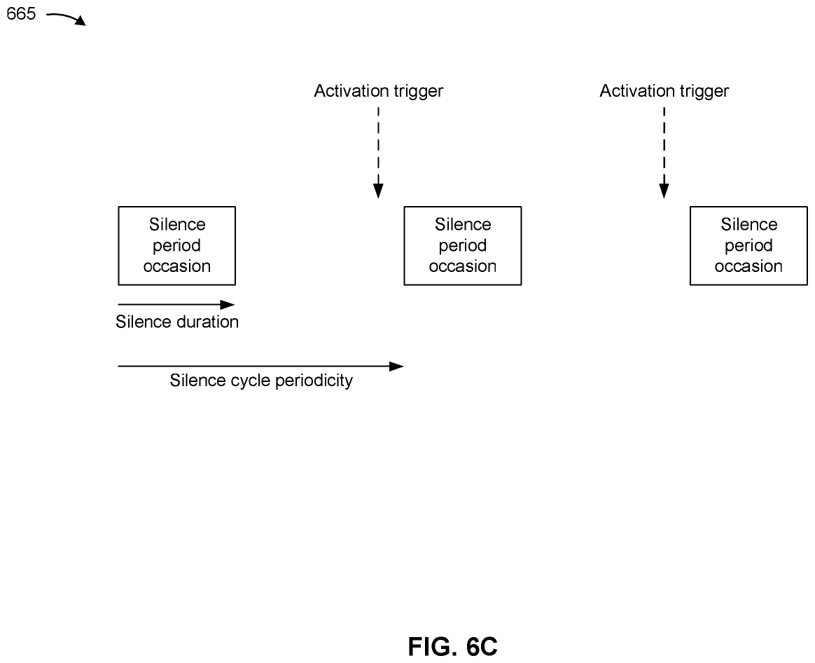

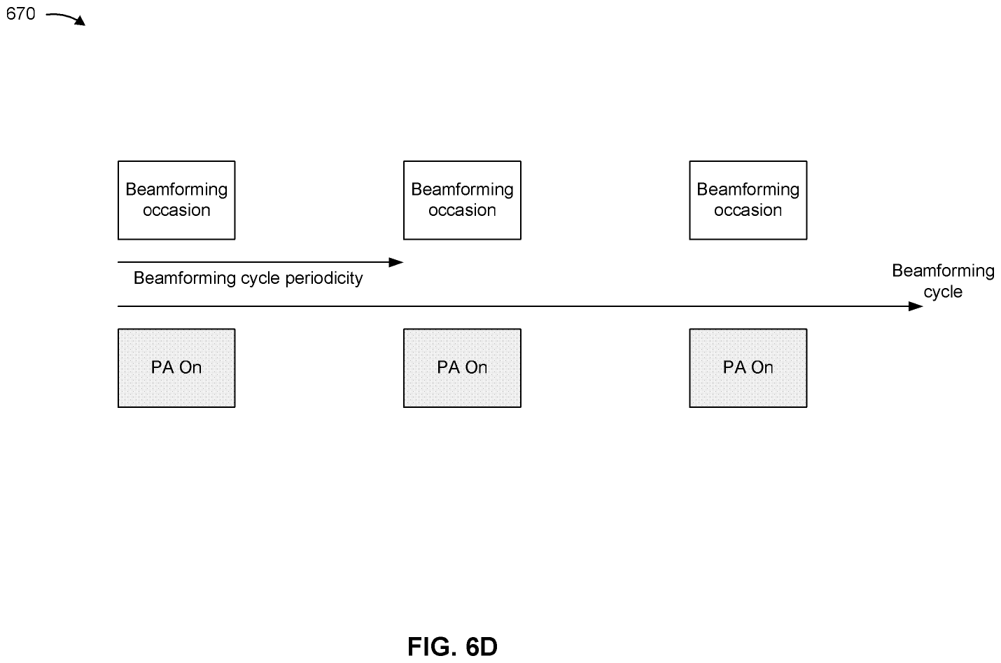

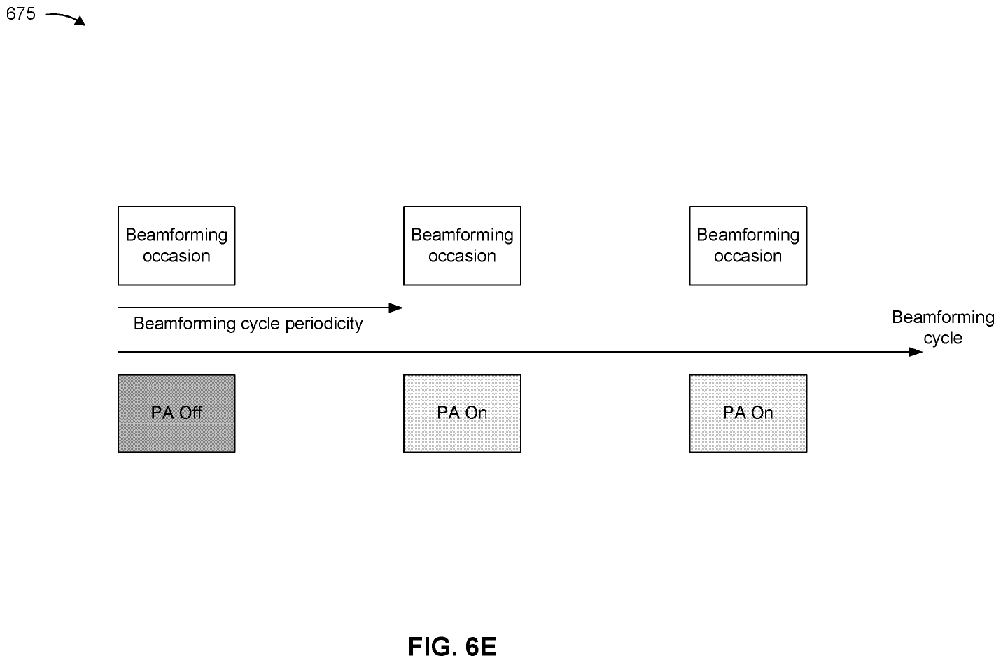

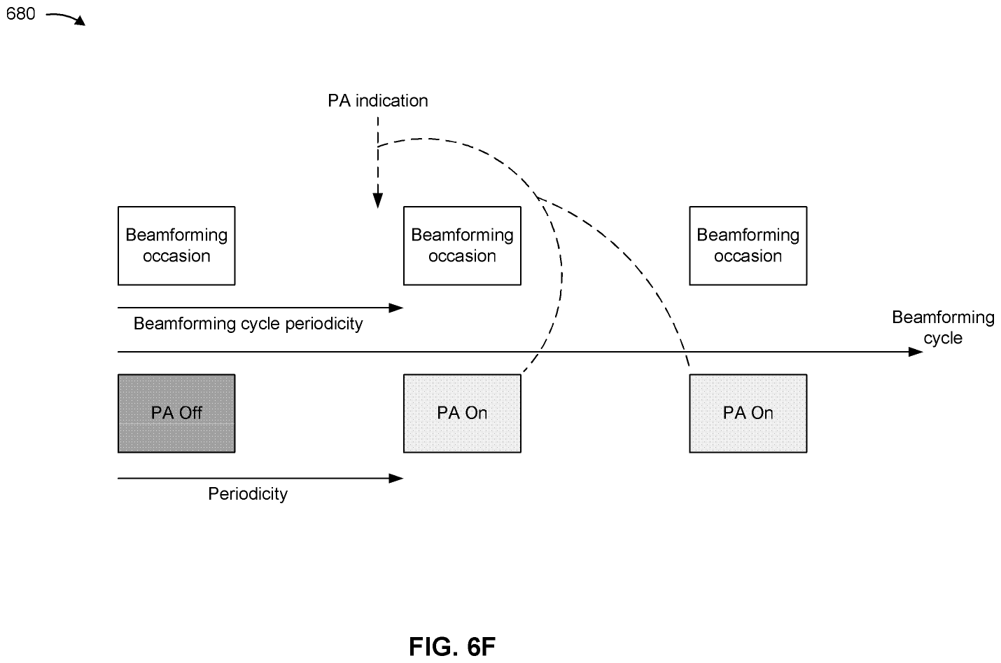

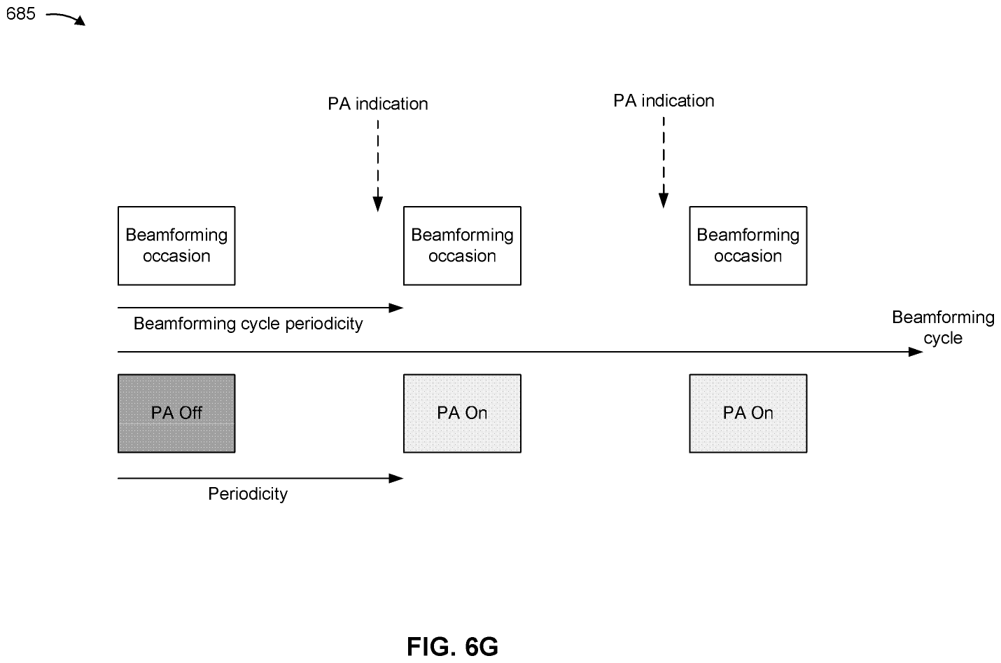

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6A-6G and 7-12).

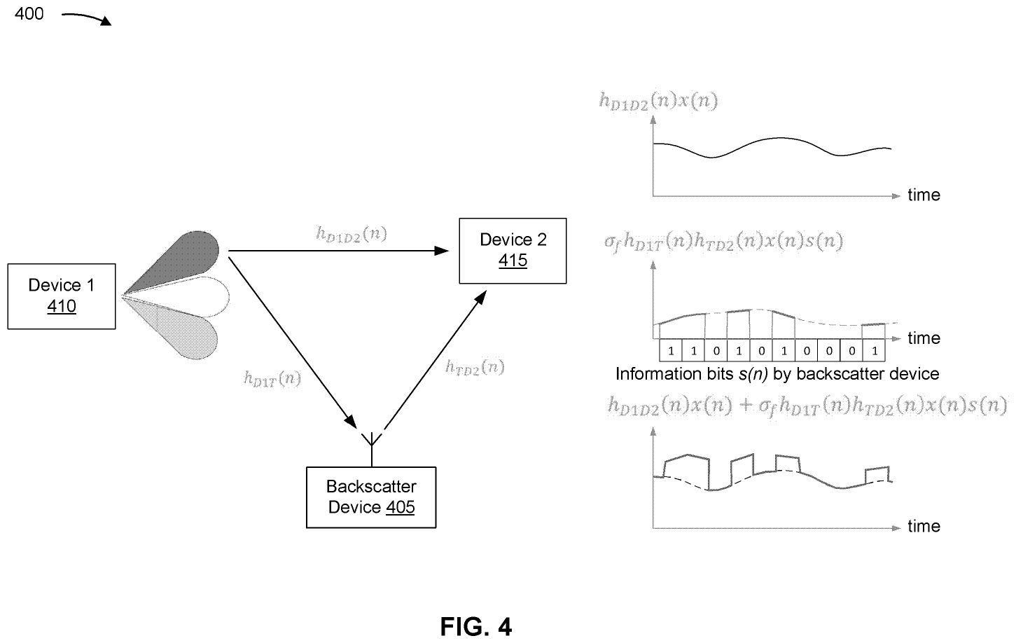

Additionally, UE 120 may further include an IoT device 505. IoT device 505 may be capable of forwarding received signals, as described elsewhere herein, but may or may not have hardware to enable the reception or transmission of configurations or capabilities. In a circumstance where the IoT device 505 lacks hardware to enable reception or transmission of configurations or capabilities, the IoT device 505 may transmit or receive configurations and capabilities via the controller/processor 280, antenna(s) 252, the modem(s) 254, and/or other components of the UE 120 and the controller/processor 280 may be capable of configuring the IoT device 505 for signal forwarding using coefficients for beamforming, as described elsewhere herein. Additionally, in cases where the IoT device 505 has power boosting capabilities, power for power amplification by the IoT device 505, when forwarding or reflecting received signals, may come from the power source of the UE 120 or may alternatively reside in the IoT device 505 itself, as discussed in greater detail elsewhere herein. In some implementations, the IoT device 505 may have a memory and one or more processors independent of the UE 120, in which case it may operate similar to a standalone IoT device 505. Such a standalone IoT device 505 that is part of UE 120 may be capable of performing the various aspects of FIGS. 4, 5, and 6A-6G described below while the UE 120 is off or in a lower power mode. Additionally or alternatively, the IoT device 505 may have minimal hardware and may use the memory 282 and one or more of processors 258, 264, 280 of the UE 120 in performing the various aspects of FIGS. 4, 5, and 6A-6G described below. In some aspects, the IoT device 505 may be a standalone IoT device 505 (not shown in FIG. 2). Here, the IoT device 505 may include one or more components similar to those of the UE 120, such as the memory 282, one or more of processors 258, 264, 280, and/or the antenna(s) 252.

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6A-6G and 7-12).

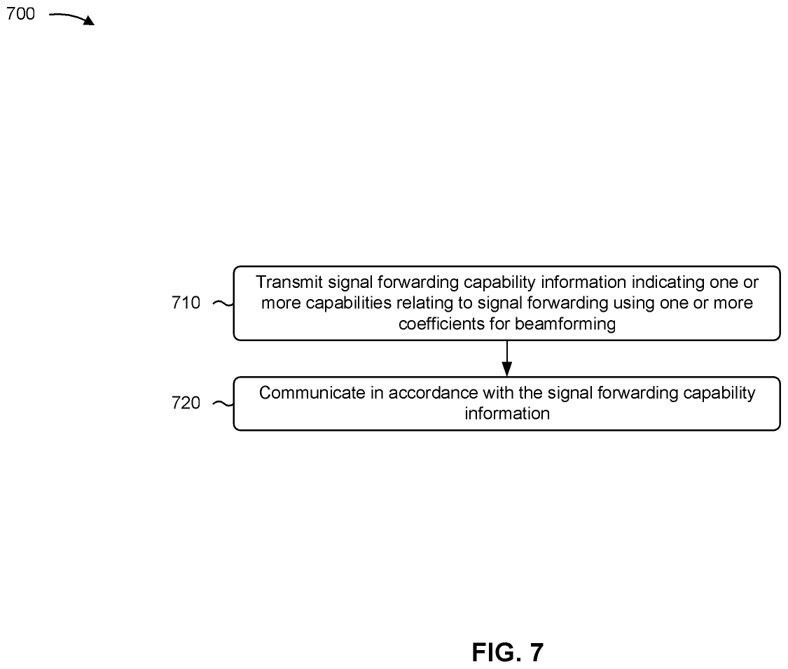

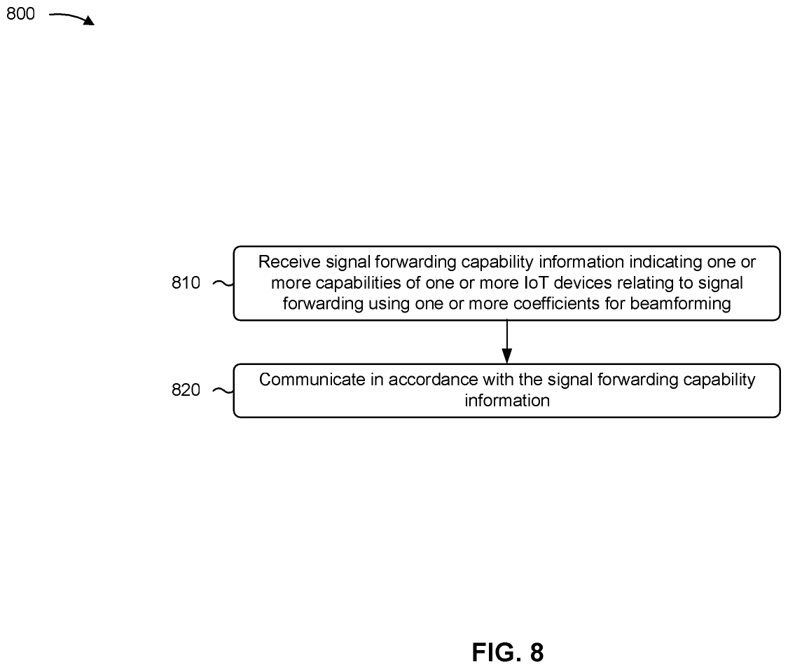

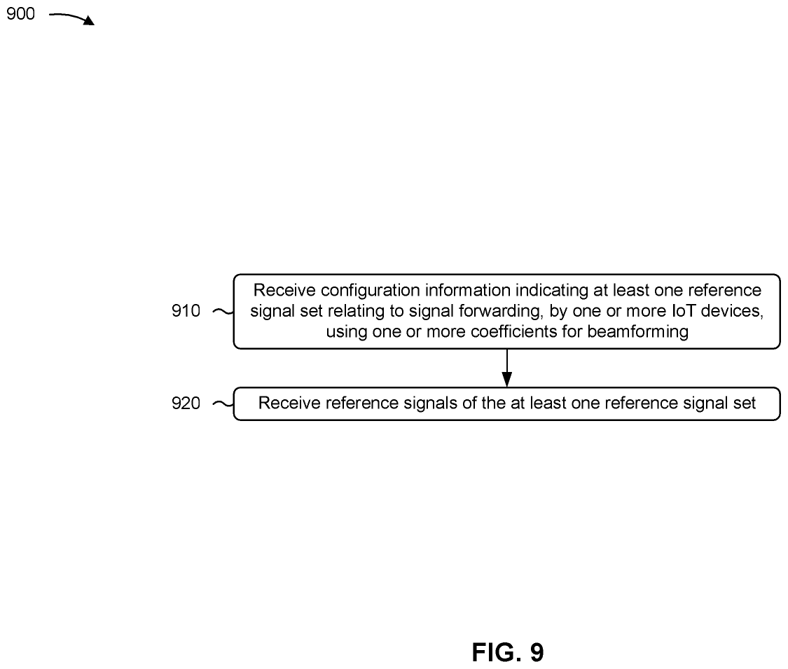

The controller/processor 240 of the network node 110, the controller/processor 280 of the UE 120, and/or any other component(s) of FIG. 2 may perform one or more techniques associated with signal forwarding using one or more coefficients, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, a UE 120 and/or an IoT device 505 includes means for transmitting signal forwarding capability information indicating one or more capabilities relating to signal forwarding using one or more coefficients (e.g., using controller/processor 280, transmit processor 264, TX MIMO processor 266, modem 254, antenna 252, memory 282, or the like); and/or means for communicating in accordance with the signal forwarding capability information (e.g., using controller/processor 280, transmit processor 264, TX MIMO processor 266, modem 254, antenna 252, memory 282, MIMO detector 256, receive processor 258, or the like). In some aspects, a UE 120 includes means for receiving configuration information indicating at least one reference signal set relating to signal forwarding, by the IoT device 505, using one or more coefficients (e.g., using antenna 252, modem 254, MIMO detector 256, receive processor 258, controller/processor 280, memory 282, or the like); and/or means for receiving reference signals of the at least one reference signal set (e.g., using antenna 252, modem 254, MIMO detector 256, receive processor 258, controller/processor 280, memory 282, or the like). The means for a UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node 110 includes means for receiving signal forwarding capability information indicating one or more capabilities of the IoT device 505 and/or a UE relating to signal forwarding using one or more coefficients (e.g., using antenna 234, modem 232, MIMO detector 236, receive processor 238, controller/processor 240, memory 242, or the like); and/or means for communicating in accordance with the signal forwarding capability information (e.g., using antenna 234, modem 232, MIMO detector 236, receive processor 238, controller/processor 240, memory 242, transmit processor 220, TX MIMO processor 230, or the like). In some aspects, the means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

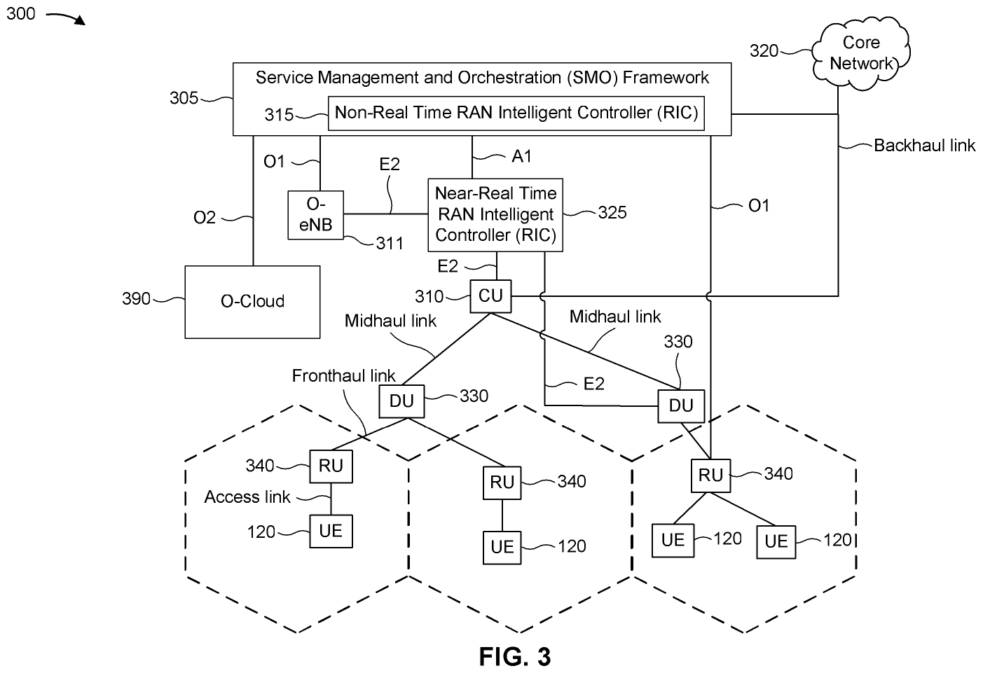

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface).

For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an 02 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example of backscatter communication, in accordance with the present disclosure.

Backscatter communication may be used in an IoT device. Here, a backscatter device 405 may collect or receive energy from an ambient RF signal and redirect or reflect the ambient RF signal, in a manner similar to an RFID tag.

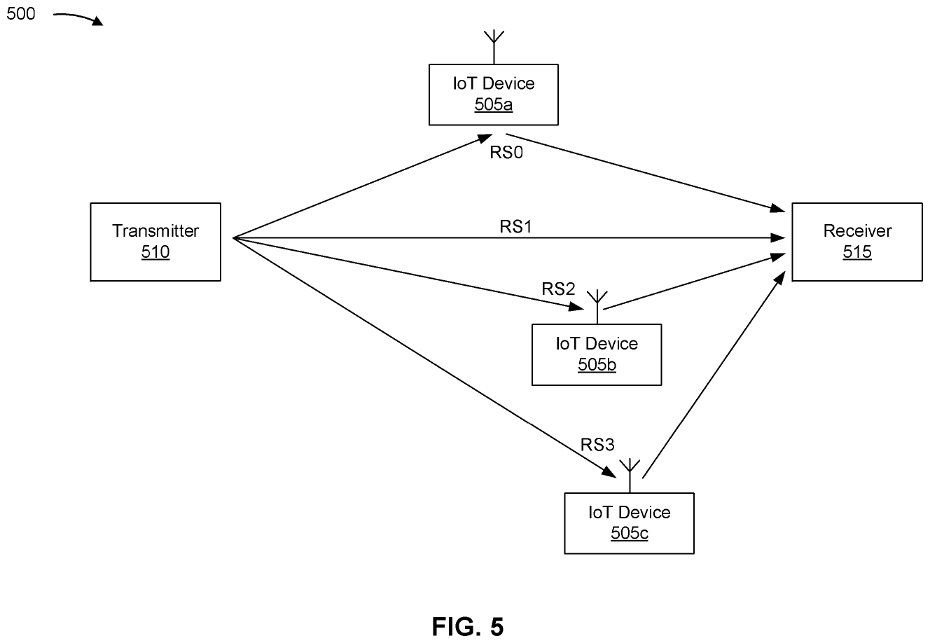

A backscatter device 405 (e.g., IoT device 505 with reference to FIGS. 2 and 5, a tag, a sensor, or the like) may employ a simplified hardware design that does not include a battery and/or does not include a radio wave generation circuit, such that the backscatter device 405 may be capable of transmitting information only by reflecting a radio wave. The backscatter device 405 may use an information modulation scheme, such as amplitude shift keying (ASK) modulation, for signal reflection. For ASK modulation, the backscatter device 405 may switch on reflection when transmitting an information bit “1” and switch off reflection when transmitting an information bit “0.”

To facilitate communication of the backscatter device 405, a first device 410 (e.g., a UE or a network node) may transmit a particular radio wave (e.g., a reference signal or a data signal), which may be denoted as x(n). The information bits of the backscatter device 405 may be denoted as s(n) where s(n) ∈{0,1}. Accordingly, the signal received at a second device 415 (e.g., a UE) may be denoted as y(n) where y(n)=(h_{D1D2}(n)+σ_{f}h_{D1T}(n)h_{TD2}(n)s(n))x(n)+noise and σ_{f} is a reflection coefficient (e.g., that characterizes losses in a reflected signal). When s(n)=0, reflection is off at the backscatter device 405, such that the second device 415 receives only a direct link signal (i.e., y(n)=h_{D1D2}(n)x(n)+noise). When s(n)=1, reflection is on at the backscatter device 405, such that the second device 415 receives a superposition of both the direct link signal and a backscatter link signal (i.e., y(n)=(h_{D1D2}(n)+σ_{f}h_{D1T}(n)h_{TD2}(n)s(n))x(n)+noise).

In the example illustrated in FIG. 4, s(n) can be understood as a data signal that is modulated by backscatter device 405 onto the signal transmitted by first device 410 (h_{D1T}(n)), thereby generating backscattered and/or reflected signal (h_{TD2}(n)). However, it can be understood that s(n) can represent a static or semi-static coefficient (e.g., s(n)=α·e^{-jβ}, for all n or some subset of n, where a is a scalar coefficient and β is a phase applied to the modulated/backscattered/reflected signal) applied by backscattering device 405 onto the signal received by the backscattering device 405. For example, α·e^{-jβ} can represent an attenuation or power boost of the signal by backscatter device 405. Hence, for example, when α·e^{-jβ}<1, backscatter device 405 is attenuating the backscattered/reflected signal such that h_{TD2}(n)<h_{D1T}(n), while when s(n)>1, the backscattering device 405 is boosting the backscattered/reflected such that signal h_{TD2}(n)>h_{D1T}(n).

Backscatter device 405 maybe an IoT device and can be, in various implementations, a passive RFID tag (e.g., an RFID tag that uses energy harvesting to temporarily power up active RF components for the communication of capabilities, configurations, etc.), a semi-passive RFID tag (e.g., an RFID tag that may have a battery, such as a rechargeable or disposable battery), or an active RFID tag. The backscatter device 405 may be a standalone device or, additionally or alternatively, may be a part of a UE, as illustrated above with reference to FIG. 2. When a part of the UE, the backscatter device 405 can communicate configurations and/or capabilities via the UE and/or can have access to a power supply of the UE. Furthermore, even if part of the UE, the backscatter device 405 can operate independently, such as when the UE is powered down or in a sleep mode.

Energy harvesting may be used by backscatter device 405, such as when backscatter device 405 is an IoT device, an enhanced reduced capability (eRedCap) IoT device, or a non-reduced capability IoT device. The energy harvested by the IoT device can be used for one or more of powering radio components to enable communication of configurations or capabilities or to power a power amplifier to enable power boosting, as described further below. A device powered by energy harvesting may opportunistically harvest energy in an environment of the device and store the energy in a rechargeable battery, a capacitor, or the like, of the device for immediate or later use. The energy in the environment of the device may come from sources such as solar, heat, and/or ambient RF radiation (such as a carrier wave transmitted to the device for the purposes of temporarily powering the device for reception or transmission of a configuration, a capability, power boosting while reflecting signal, and/or the like), among other examples. In some cases, techniques may be needed to support operation of devices when energy for harvesting is intermittently available. In particular, variations of the amount of harvested energy at a device and/or variations in traffic at the device can be expected. However, a device operating using intermittently available harvested energy may be unable to sustain long or continuous reception and/or transmission.

As indicated above, FIG. 4 is provided as an example. Other examples may differ from what is described with regard to FIG. 4.

FIG. 5 is a diagram illustrating an example of communication using distributed antennas, in accordance with the present disclosure.

Backscatter devices (such as backscatter device 405 with reference to FIG. 4), including tags and energy harvesting devices with energy storage devices (e.g., rechargeable batteries, capacitors, or the like) or other power storage capability, as described above, may be used as distributed antennas in a wireless system. For example, IoT device 505 (e.g., backscatter device 405 with reference to FIG. 4, RFID tags and/or energy harvesting devices, UEs with integrated IoT device 505 or UEs capable of configuring backscatter device 405, etc.) may be used to align or beamform data from a transmitter device 510 (e.g., a UE or a network node) to a receiver device 515 (e.g., a UE), such as from one UE to another UE (e.g., if there is no direct path from the transmitter device 510 to the receiver device 515 or otherwise). To enable beamforming using amplitude or phase (e.g., α or β with reference to FIG. 4), the transmitter device 510 may configure one or more reference signals (shown as RS0, RS1, RS2, and RS3) to determine one or more coefficients (e.g., a coefficient for beamforming, for example, s(n)=α·e^{-jβ} with reference to FIG. 4), as described in connection with FIGS. 6A-6G, that is to be used for each IoT device 505. Additionally, or alternatively, the transmitter device 510 (e.g., a network node) may determine one or more coefficients for each IoT device 505, and the transmitter device 510 may transmit the determined coefficient(s) to each IoT device individually. However, wireless networks generally may lack support for techniques to signal, configure, indicate, or otherwise enable signal forwarding, such as for IoT devices, IoT relays, and/or relay UEs with low complexity and/or a rechargeable battery (e.g., reduced capability UEs), such as UEs with or without IoT device 505. As a result, the performance of communications between the transmitter device 510 and the receiver device 515 may suffer, particularly if a direct path from the transmitter device 510 to the receiver device 515 is blocked.

Some techniques and apparatuses described herein enable signal forwarding by backscatter devices, such as passive, semi-passive, or active IoT devices, using one or more coefficients (e.g., coefficients for beamforming). In some aspects, an IoT device (e.g., whether integrated as a part of a UE or stand alone) may signal one or more capabilities relating to signal forwarding using one or more coefficients, thereby facilitating use of the IoT device for signal forwarding to improve the performance of communications between a transmitter device and a receiver device. In some aspects, one or more reference signal sets, relating to signal forwarding using one or more coefficients, may be used to determine coefficients that one or more IoT devices are to use for signal forwarding. The coefficient(s) may facilitate individual or coordinated beamforming by the IoT devices as well as facilitate the alignment of forwarded signals from the IoT devices, thereby improving the performance of communications between a transmitter device and a receiver device. In some aspects, an IoT device may be configured with a beamforming duration, during which communications at the IoT device, other than signal forwarding, are to be absent, and/or a silence duration during which communications at the IoT device, including signal forwarding, are to be absent. In this way, aligning and coordinating beamforming may be achieved, while reducing interference between IoT devices performing signal forwarding. Furthermore, as IoT devices may vary in capability, with some IoT devices being capable of boosting the power of a backscattered or reflected or forwarded signal (e.g., IoT devices having a power amplifier) and others not having power boosting capability (e.g., IoT devices not having a power amplifier or having a power amplifier but not having sufficient power to amplify a signal due to current lack of power for powering the power amplifier), an IoT device may also communicate its signal forwarding capability to the transmitting device and/or the network.

As indicated above, FIG. 5 is provided as an example. Other examples may differ from what is described with regard to FIG. 5.

FIG. 6A is a diagram illustrating an example 600 associated with signal forwarding using one or more coefficients, in accordance with the present disclosure. As shown in FIG. 6A, a source device 605, one or more IoT devices 505 (shown as IoT device 505a to IoT device 505n), and a reader device 610 may communicate with one another. A IoT device 505 may include RFID and similar devices as described elsewhere herein, including energy harvesting devices (e.g., that include a rechargeable battery). In one implementation, a UE 120 may include an IoT device 505 and have a capability to communicate (e.g., forwarding signals) using the IoT device 505. In one implementation, a UE 120 may support both RFID tag radio and a main radio (e.g., NR, LTE, or combination thereof). The UE 120 may use the RFID tag radio in a low-power mode (e.g., at a lower power than a power at which the main radio is used). The source device 605 may be a UE 120 or a network node 110. The reader device 610 may be a UE 120.

As shown by reference number 615, the IoT device(s) 505 may transmit (e.g., report), and the source device 605 may receive, signal forwarding capability information indicating one or more capabilities of the IoT device(s) 505 relating to signal forwarding using one or more coefficients for beamforming. That is, the source device 605 may receiving signal forwarding capability information from one or more IoT devices 505 (e.g., at least one IoT device 505 or multiple IoT devices 505). The IoT device(s) 505 may communicate in accordance with the signal forwarding capability information, as described herein.

In some aspects, for example, IoT device 505a may have a single antenna, in which case beamforming is performed by the IoT device 505a and at least one other IoT device, such as the IoT device 505b. Here, a first coefficient for beamforming (as described with reference to FIGS. 4 and 5) may be used by the IoT device 505a (e.g., applied to the antenna of the IoT device 505a), and a second coefficient for beamforming may be used by the IoT device 505b. In some aspects, for example, the IoT device 505a may have multiple antennas, in which case beamforming may be performed by the IoT device 505a alone or with at least one other IoT device (e.g., IoT device 505b). Here, multiple coefficients may be used by the IoT device 505a (e.g., applied to respective antennas of the IoT device 505a).

In some aspects, the one or more capabilities may indicate a capability of the IoT device(s) 505 for power boosting (e.g., a capability of adding power boosting to a forwarded signal). For example, IoT devices may have active components, such as a power amplifier (PA), to enable boosting the power of a backscattered signal. In some aspects, the one or more capabilities may indicate one or more power boosting states usable by the IoT device(s) 505 and/or a maximum power boosting level usable by the IoT device(s) 505. For example, the power boosting states and/or the maximum power level may be indicated as part of the capability indication for power boosting. In general, an IoT device may have a few states for boosting a signal under a low power constraint. Signaling the power boosting states and/or the maximum power level may enable another device (e.g., the source device 605) to assist the IoT device(s) 505 in optimizing power levels.

In some aspects, the one or more capabilities may indicate at least one of an amplitude resolution usable by the IoT device(s) 505 (e.g., a value that indicates a size of a step by which the IoT device(s) 505 can change amplitude, such as 0.1) or a phase resolution usable by the IoT device(s) 505 (e.g., a value that indicates a size of a step by which the IoT device(s) 505 can change phase, such as 5 degrees). That is, the one or more capabilities may indicate a granularity for a coefficient (e.g., a beamforming coefficient) of which the IoT device(s) 505 is capable. In some aspects, the one or more capabilities may indicate a class of the IoT device(s) 505. The class may indicate one or more power levels usable by the IoT device(s) 505 (e.g., power boosting states), an amplitude resolution usable by the IoT device(s) 505, a phase resolution usable by the IoT device(s) 505, and/or whether the IoT device(s) 505 has (e.g., is equipped with) multiple antennas, among other examples. Indication of the class may enable another device (e.g., the source device 605) to assist the IoT device(s) 505 in selecting the best coefficient(s).

As shown by reference number 620, the source device 605 may transmit, and the IoT device(s) 505 may receive, configuration information. In some aspects, the configuration information may indicate at least one reference signal set (e.g., one or more reference signals) relating to signal forwarding using one or more coefficients for beamforming (e.g., the at least one reference signal set may be used for determining one or more coefficients for beamforming). For example, the reference signal set(s) may be used by the IoT device(s) 505, the source device 605, and/or the reader device 610 for measurement, computation, and determination of one or more coefficients (e.g., that are to be used by one or more of the IoT devices 505) for beamforming a signal at the reader device 610. The reference signal set(s) may be periodic and/or triggered (e.g., by the source device 605). In some aspects, the power amplifier of the IoT device(s) 505 may be activated (e.g., turned on) during training using the reference signal set(s).

In some aspects, the configuration information may include an indication of a beamforming duration, as described further in connection with FIG. 6B. For example, the indication may indicate the beamforming duration and/or indicate a beamforming cycle that includes a beamforming duration (i.e., an active time for beamforming) and a periodicity. The beamforming duration (i.e., a beamforming occasion having the beamforming duration) may be a time period in which the IoT device(s) 505 is to perform signal forwarding, and in which the IoT device(s) 505 is not to receive commands from other devices (e.g., the source device 605 and/or the reader device 610) to write data to the IoT device(s) 505 (e.g., data is not to be sent to the IoT device) or to receive a request to send (e.g., transmit) data (e.g., data that is stored/buffered by the IoT device) using backscattering (e.g., data of the Iot device(s) 505 is not to be read by another device). In some aspects, active RF components of the IoT device(s) 505, such as the power amplifier, may be activated (e.g., turned on) in the beamforming duration (e.g., in accordance with a layer 1 (L1), layer 2 (L2), or layer 3 (L3) configuration of the IoT device), as described further in connection with FIGS. 6D-6G. In some aspects, one or more beamforming occasions (e.g., every M beamforming occasions/cycles, where M is L1/L2/L3 configured), may be associated with a beamforming activation signal, where the signal indicates activation of the next one or more beamforming occasions/cycles and also may indicate the activation (and also settings) of the power amplifier or other active RF components. A default state for a power amplifier (e.g., an on state or an off state) may be agreed upon, and the configuration (or reconfiguration) of the power amplifier (or other active RF components) and/or a change or update to the default state may occur over time by L1/L2/L3 signaling. The beamforming activation signaling may indicate that the power amplifier is to be turned on or turned off based on whether the default state is an on state or an off state. In some aspects, the IoT device(s) 505 may be configured with monitoring occasions, standalone monitoring occasions, or occasions that are associated with the beamforming occasions or associated with monitoring occasions for the beamforming activation signaling, to turn on or off the power amplifier (or other active RF components).

In some aspects, the configuration information may include an indication of a silence duration, as described further in connection with FIG. 6C. For example, the indication may indicate the silence duration and/or indicate a silence cycle that includes a silence duration (i.e., a time duration where the IoT device 505(s) is silent) and a periodicity. The silence duration (i.e., a silence period occasion having the silence duration) may be a time period in which the IoT device(s) 505 is not to receive commands from other devices, not to write data to the IoT device(s) 505, not to receive a request to send (e.g., transmit) data (e.g., data that is stored/buffered by the IoT device) using backscattering, or not to receive a request to perform signal forwarding by beamforming. In some aspects, active RF components of the IoT device(s) 505, such as the power amplifier, may be deactivated (e.g., turned off) in the silence duration. Thus, the IoT device(s) 505 may be silent during the silence duration to enable communication by other devices without interference from the IoT device(s) 505. In some aspects, the time period for the beamforming duration may be equal in length to, or different in length from, the time period for the silence duration. In some aspects, one or more silence period occasions/cycles (e.g., every K silence period occasions/cycles, where K is L1/L2/L3 configured) may be associated with a silence period activation signal, where the signal indicates activation of the next one or more silence period occasions/cycles.

The configuration information may be signaled using Li signaling (e.g., downlink control information (DCI), L2 signaling, or L3 signaling. As shown, the reader device 610 may also receive configuration information. For example, the configuration information received by the reader device 610 may indicate the at least one reference signal set, the beamforming duration/cycle, and/or the silence duration/cycle. Where an IoT device 505 is part of a UE 120 that has a main radio (MR), the configuration information may be signaled using L1 signaling (e.g., DCI signaling), L2 signaling (e.g., medium access control (MAC) control element (MAC-CE) signaling), or L3 signaling (e.g., RRC signaling) while the main radio is active. During times when the main radio is inactive (e.g., off), updates or changes to configurations, power amplifier (or other active RF components) configurations, a power amplifier default state (e.g., whether the power amplifier is on or off by default), beamforming cycles, and/or silence period cycles may be transmitted to the IoT device 505 (of the UE 120) using L1 signaling, L2 signaling, or L3 signaling.

As shown by reference number 625, the source device 605 may transmit, and the IoT device(s) 505 may receive, an indication to activate (e.g., turn on) or deactivate (e.g., turn off) a power amplifier, and/or another active RF component, of the IoT device(s) 505. The power amplifier, and other active RF components, are power consuming, and thus the indication facilitates power saving. In some aspects, the power amplifier, and/or other active RF components, may be activated by the IoT device(s) 505 during a time period associated with a beamforming duration. In some implementations, where IoT device(s) 505 is part of a UE(s) 120, the power amplifier and/or other active RF components may be parts of the UE(s) 120 and used by the IoT device(s) 505. In some aspects, the power amplifier (or the other active RF components) may be configured to be turned on during beamforming occasions or a subset of beamforming occasions, or in other cases, may be configured to be turned on or off for a duration using L1/L2/L3 signaling (and the duration may be configured using L1/L2/L3 signaling).

As shown by reference number 630, the source device 605 may transmit, and the IoT device(s) 505 may receive, an indication to begin signal forwarding (e.g., to begin backscattering, reflecting, or beamforming). In some aspects, this indication may also include, or may accompany, the indication to activate or deactivate the power amplifier, the indication of the beamforming duration, and/or the indication of the silence duration.

As shown by reference number 635, the source device 605 may transmit a reference signal set (e.g., one of the configured reference signal sets), beamformed in different directions, which may be received by the reader device 610. Moreover, the IoT device(s) 505 may perform forwarding (e.g., perform backscattering, reflecting, or beamforming) of the reference signal set, and the reader device 610 may receive the forwarded reference signal set. As shown by reference number 640, the reader device 610 may perform measurements (e.g., measure an RSRP and/or a signal to interference plus noise ratio (SINR)) of reference signals of the reference signal set to determine one or more reference signals (e.g., one or more best reference signals) and/or one or more coefficients for beamforming for the IoT device(s) 505 (e.g., for each of the IoT device(s) 505 that forwarded reference signals to the reader device 610). In some aspects, the reader device 610 may use the measurements to determine a combination (e.g., a best combination) of IoT device(s) 505 (e.g., RFID devices), which forwarded reference signals to the reader device 610, that cause a signal at the reader device 610 associated with a highest metric (e.g., relative to any other combination of IoT device(s) 505). The metric may be an RSRP, an RSRQ, an SINR, an energy metric, and/or another metric.

As shown by reference number 645, the reader device 610 may transmit (e.g., based at least in part on receiving the reference signal set), and the source device 605 may receive, information indicating the reference signal(s) (e.g., by indices) and/or the coefficient(s) for beamforming for the IoT device(s) 505 determined by the reader device 610. In some aspects, the information may also indicate the combination of IoT device(s) 505 that are to be used for signal forwarding to the reader device 610. In some aspects, the information may also indicate a timing (e.g., a best timing) and/or a beamforming time offset and/or phase shift for signal forwarding by multiple IoT device(s) 505 (e.g., RFID devices) to the reader device 610. The timing and/or beamforming time offset may enable coherent combining of forwarded signals of the IoT device(s) 505 at the reader device 610. For example, the source device 605 may use the timing, the beamforming time offset, and/or phase shift to perform a data transmission in a manner such that an end-to-end signal from the source device 605 to the reader device 610, after forwarding by the IoT device 505a (e.g., an RFID device), is aligned (e.g., in time) with the same signal forwarded by the IoT device 505b (e.g., another RFID device). In some aspects, the reader device 610 may transmit such information (e.g., indicating the coefficient(s)) directly to the IoT device(s) 505 (e.g., rather than to the source device 605).

As shown by reference number 650, the source device 605 may transmit, and the IoT device(s) 505 may receive, an indication of at least one coefficient for beamforming for at least one antenna of the IoT device(s) 505 (e.g., if the coefficient(s) were not indicated to the IoT device(s) 505 directly by the reader device 610). For example, the source device 605 may indicate (e.g., set) one or more coefficients for beamforming for multiple IoT devices 505, such as IoT device 505a and IoT devices 505b, used for signal forwarding to the reader device 610. In this way, each IoT device 505 (e.g., each RFID device) used for signal forwarding to the reader device 610 may receive a respective indication of one or more coefficients that are to be used by the IoT device 505. In some aspects, a coefficient indicated by the source device 605 may be the same as a coefficient indicated to the source device 605 by the reader device 610 (e.g., the source device 605 indicates the coefficient as is). In some aspects, a coefficient indicated by the source device 605 may be modified (e.g., adjusted) from a coefficient indicated to the source device 605 by the reader device 610.

A coefficient (e.g., a beam weight) may indicate an amplitude and a phase that is to be used for a forwarded signal, as described with reference to FIGS. 4 and 5. For example, the forwarded signal may be characterized by the expression P×α×exp(−j×β), where P represents a power state (e.g., from a set, such as {1.5, 2, 4, . . . }), α represents an amplitude (e.g., from a set, such as {0.3, 0.4, 0.5, 1}), and exp(−j×β) represents a phase (e.g., where p is from a set, such as {20, 45, . . . }). Thus, the coefficient may indicate α×exp(−j×β) of the expression.

In some aspects, a beamforming coefficient may be “1,” for example, α=1 and β=0. In some aspects, a silence period may be triggered by a beamforming coefficient with α=0 (regardless of a value of #). In some aspects, a value of β may be used to map to a silence period interval or to indicate a particular silence period cycle or pattern (e.g., among a plurality of silence period configurations) when α=0.

The IoT device(s) 505 (e.g., each IoT device 505 used for signal forwarding) may apply the indicated coefficient(s) to the antenna(s) of the IoT device(s) 505. For example, during a data transmission from the source device 605 to the reader device 610, the IoT device(s) 505 (e.g., each IoT device 505 used for signal forwarding) may set the indicated coefficient(s) on the antenna(s) of the IoT device(s) 505. As shown by reference number 655, the source device 605 may perform a data transmission to the reader device 610. Here, the IoT device(s) 505 (e.g., each IoT device 505 used for signal forwarding) may forward the data transmission to the reader device 610 using the indicated coefficient(s) on the antenna(s) of the IoT device(s) 505. In some aspects, the IoT device(s) 505 may forward the data transmission to the reader device 610 using the indicated coefficient(s) on the antenna(s) of the IoT device(s) 505 during a beamforming duration, and/or the IoT device(s) 505 may refrain from forwarding the data transmission during a silence duration. In some aspects, a silence period may be triggered by an indication of an amplitude or a beamforming coefficient of zero across the one or more antennas at the IoT device(s) 505. In this way, the IoT device(s) 505 (e.g., RFID devices) used for signal forwarding may beamform (e.g., individually and/or in combination) the data transmission to the reader device 610, thereby improving the performance of communications between the source device 605 and the reader device 610.

As indicated above, FIG. 6A is provided as an example. Other examples may differ from what is described with respect to FIG. 6A.

FIG. 6B is a diagram illustrating an example 660 associated with signal forwarding using one or more coefficients, in accordance with the present disclosure.

FIG. 6B shows a plurality of beamforming occasions associated with a beamforming duration, as described above in connection with FIG. 6A. As shown, each beamforming occasion (e.g., each beamforming cycle) may be associated with an activation trigger for the beamforming occasion. The activation trigger may be L1, L2, or L3 signaling from a network node 110 to an IoT device (e.g., IoT device 505), in a similar manner as described above, indicating whether the next beamforming occasion is to be activated. In some aspects, an activation trigger may indicate that a group of M (M>1) beamforming occasions (e.g., beamforming cycles) are to be activated. Here, subsequent activation triggers, corresponding to the group of M beamforming occasions, are not needed. In some aspects, a value of M may be configured for an IoT device by L1, L2, and/or L3 signaling. The IoT device may not activate a beamforming occasion if an activation trigger for the beamforming occasion is not received.

As indicated above, FIG. 6B is provided as an example. Other examples may differ from what is described with respect to FIG. 6B.

FIG. 6C is a diagram illustrating an example 665 associated with signal forwarding using one or more coefficients, in accordance with the present disclosure.

FIG. 6C shows a plurality of silence period occasions associated with a silence duration, as described above in connection with FIG. 6A. As shown, each silence period occasion (e.g., each silence period cycle) may be associated with an activation trigger for the silence period occasion. The activation trigger may be L1, L2, and/or L3 signaling from a network node 110 to an IoT device (e.g., IoT device 505), in a similar manner as described above, indicating whether the next silence period occasion is to be activated. In some aspects, an activation trigger may indicate that a group of K (K>1) silence period occasions (e.g., silence period cycles) are to be activated. Here, subsequent activation triggers, corresponding to the group of K silence period occasions, are not needed. In some aspects, a value of K may be configured for an IoT device by L1, L2, and/or L3 signaling. The IoT device may not activate a silence period occasion if an activation trigger for the silence period occasion is not received.

As indicated above, FIG. 6C is provided as an example. Other examples may differ from what is described with respect to FIG. 6C.

FIG. 6D is a diagram illustrating an example 670 associated with signal forwarding using one or more coefficients, in accordance with the present disclosure.

FIG. 6D shows a plurality of beamforming occasions, as described above. As shown, in some aspects, an IoT device (e.g., IoT device 505) may activate a power amplifier of the IoT device for all beamforming occasions (e.g., by default).

As indicated above, FIG. 6D is provided as an example. Other examples may differ from what is described with respect to FIG. 6D.

FIG. 6E is a diagram illustrating an example 675 associated with signal forwarding using one or more coefficients, in accordance with the present disclosure.

FIG. 6E shows a plurality of beamforming occasions, as described above. As shown, in some aspects, an IoT device (e.g., IoT device 505) may activate a power amplifier of the IoT device for a subset of the beamforming occasions (e.g., for less than all of the beamforming occasions). The subset of beamforming occasions (e.g., which of the beamforming occasions) for which the IoT device is to activate the power amplifier may be configured for the IoT device using L1, L2, and/or L3 signaling. For example, the subset may be configured for the IoT device with the configuration of the beamforming cycle for the IoT device, as described above in connection with FIG. 6A. The IoT device may not activate the power amplifier for beamforming occasions that are not in the subset of beamforming occasions.

As indicated above, FIG. 6E is provided as an example. Other examples may differ from what is described with respect to FIG. 6E.

FIG. 6F is a diagram illustrating an example 680 associated with signal forwarding using one or more coefficients, in accordance with the present disclosure.

FIG. 6F shows a plurality of beamforming occasions, as described above. As shown, in some aspects, an IoT device (e.g., IoT device 505) may receive a power amplifier indication (e.g., from a network node 110) prior to a beamforming occasion.

The power amplifier indication may indicate that the IoT device is to activate a power amplifier of the IoT device for a next X(where X is 1, 2, 3, or 4) beamforming occasions (and deactivate the power amplifier thereafter). Thus, the IoT device may not activate the power amplifier for a beamforming occasion until a power amplifier indication is received.

As indicated above, FIG. 6F is provided as an example. Other examples may differ from what is described with respect to FIG. 6F.

FIG. 6G is a diagram illustrating an example 685 associated with signal forwarding using one or more coefficients, in accordance with the present disclosure.

FIG. 6G shows a plurality of beamforming occasions, as described above. As shown, in some aspects, an IoT device (e.g., IoT device 505) may receive a power amplifier indication (e.g., from a network node 110) prior to each beamforming occasion. The power amplifier indication may indicate that the IoT device is to activate a power amplifier of the IoT device for the next beamforming occasion (and deactivate the power amplifier thereafter). Thus, if a power amplifier indication is not received prior to a beamforming occasion, the IoT device may not activate the power amplifier for the beamforming occasion.

As indicated above, FIG. 6G is provided as an example. Other examples may differ from what is described with respect to FIG. 6G.

FIG. 7 is a diagram illustrating an example process 700 performed, for example, by an IoT device, in accordance with the present disclosure. Example process 700 is an example where the IoT device(e.g., IoT device 505) performs operations associated with signal forwarding using one or more coefficients for beamforming.

As shown in FIG. 7, in some aspects, process 700 may include transmitting signal forwarding capability information indicating one or more capabilities relating to signal forwarding using one or more coefficients for beamforming (block 710). For example, the IoT device (e.g., using communication manager 140 and/or transmission component 1004, depicted in FIG. 100) may transmit signal forwarding capability information indicating one or more capabilities relating to signal forwarding using one or more coefficients for beamforming, as described above, for example, with reference to FIG. 6.

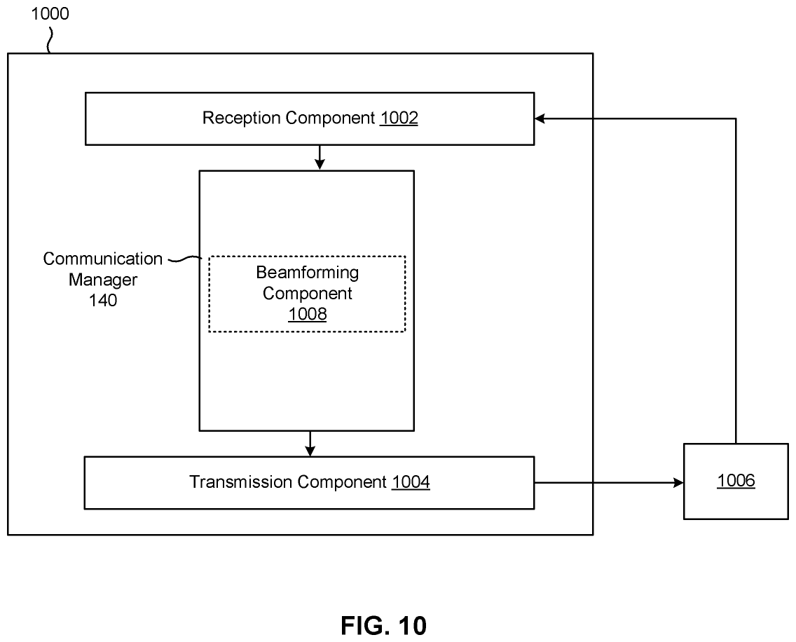

As further shown in FIG. 7, in some aspects, process 700 may include communicating in accordance with the signal forwarding capability information (block 720). For example, the IoT device (e.g., using communication manager 140, reception component 1002, and/or transmission component 1004, depicted in FIG. 10) may communicate (e.g., forward signals transmitted to the IoT device using backscattering and/or reflection techniques described herein in accordance with one or more coefficients for beamforming) in accordance with the signal forwarding capability information, as described above, for example, with reference to FIG. 6.

Process 700 may include additional aspects, such as any single aspect or any combination of aspects described below and/or in connection with one or more other processes described elsewhere herein.

In a first aspect, the IoT device is a radio frequency identification (RFID) tag radio.

In a second aspect, the IoT device is an RFID tag radio that is part of a UE, and where the UE is enabled to communicate using the RFID tag radio while the UE is in a low-power mode or based at least in part on a configuration to operate the RFID tag radio.

In a third aspect, alone or in combination with one or more of the first and second aspects, the one or more capabilities indicate a capability of the IoT device for power boosting.

In a fourth aspect, alone or in combination with one or more of the first through third aspects, the one or more capabilities indicate one or more power boosting states usable by the IoT device and a maximum power boosting level usable by the IoT device.

In a fifth aspect, alone or in combination with one or more of the first through fourth aspects, the one or more capabilities indicate at least one of an amplitude resolution usable by the IoT device or a phase resolution usable by the IoT device.

In a sixth aspect, alone or in combination with one or more of the first through fifth aspects, the one or more capabilities indicate a class of the IoT device that indicates at least one of one or more power levels usable by the IoT device, an amplitude resolution usable by the IoT device, a phase resolution usable by the IoT device, or whether the IoT device has multiple antennas.

In a seventh aspect, alone or in combination with one or more of the first through sixth aspects, process 700 includes receiving an indication to activate or deactivate a power amplifier.

In an eighth aspect, alone or in combination with one or more of the first through seventh aspects, process 700 includes receiving configuration information indicating at least one reference signal set relating to signal forwarding.

In a ninth aspect, alone or in combination with one or more of the first through eighth aspects, process 700 includes receiving an indication of the one or more coefficients for at least one antenna of the IoT device.

In a tenth aspect, alone or in combination with one or more of the first through ninth aspects, a phase indication of the one or more coefficients indicates a silence duration for a silence period or a configuration for the silence period, when an amplitude indication of the one or more coefficients indicates a zero value.

In an eleventh aspect, alone or in combination with one or more of the first through tenth aspects, process 700 includes receiving an indication of a beamforming duration, in which the IoT device is to perform signal forwarding, and in which the IoT device is not to receive a command to write to the IoT device or not to receive a request to transmit data that is stored by the IoT device by backscattering.

In a twelfth aspect, alone or in combination with one or more of the first through eleventh aspects, process 700 includes receiving an indication of a silence duration, in which the IoT device is not to receive a command to write to the IoT device, not to receive a request to transmit data that is stored by the IoT device by backscattering, or not to receive a request to perform signal forwarding by beamforming.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network node, in accordance with the present disclosure. Example process 800 is an example where the network node (e.g., network node 110) performs operations associated with signal forwarding using one or more coefficients for beamforming.

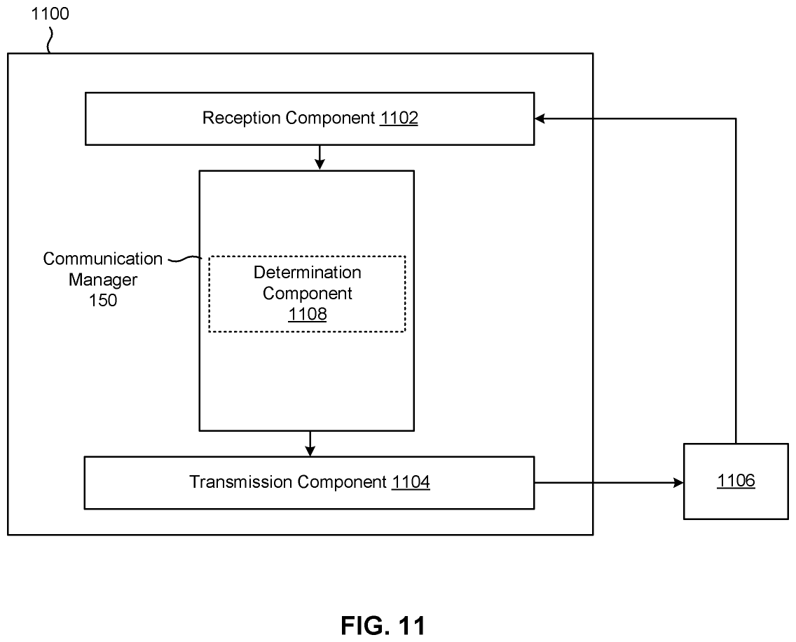

As shown in FIG. 8, in some aspects, process 800 may include receiving signal forwarding capability information indicating one or more capabilities of an IoT device relating to signal forwarding using one or more coefficients for beamforming (block 810). For example, the network node (e.g., using communication manager 150 and/or reception component 1102, depicted in FIG. 11) may receive signal forwarding capability information indicating one or more capabilities of an IoT device relating to signal forwarding using one or more coefficients for beamforming, as described above, for example, with reference to FIG. 6.

As further shown in FIG. 8, in some aspects, process 800 may include communicating in accordance with the signal forwarding capability information (block 820). For example, the network node (e.g., using communication manager 150, reception component 1102, and/or transmission component 1104, depicted in FIG. 11) may communicate (e.g., transmit signals to the IoT device for forwarding) in accordance with the signal forwarding capability information, as described above, for example, with reference to FIG. 6.

Process 800 may include additional aspects, such as any single aspect or any combination of aspects described below and/or in connection with one or more other processes described elsewhere herein.

In a first aspect, the one or more capabilities indicate a capability of each of the one or more IoT devices for power boosting.

In a second aspect, alone or in combination with the first aspect, the one or more capabilities indicate one or more power boosting states usable by each of the one or more IoT devices and a maximum power boosting level usable by each of the one or more IoT devices.

In a third aspect, alone or in combination with one or more of the first and second aspects, the one or more capabilities indicate at least one of an amplitude resolution usable by each of the one or more IoT devices or a phase resolution usable by each of the one or more IoT devices.

In a fourth aspect, alone or in combination with one or more of the first through third aspects, the one or more capabilities indicate a class of each of the one or more IoT devices that indicates at least one of one or more power levels usable by each of the one or more IoT devices, an amplitude resolution usable by each of the one or more IoT devices, a phase resolution usable by each of the one or more IoT devices, or whether each of the one or more IoT devices has multiple antennas.

In a fifth aspect, alone or in combination with one or more of the first through fourth aspects, process 800 includes transmitting an indication to activate or deactivate a power amplifier to each of the one or more IoT devices.

In a sixth aspect, alone or in combination with one or more of the first through fifth aspects, process 800 includes transmitting configuration information indicating at least one reference signal set relating to signal forwarding.

In a seventh aspect, alone or in combination with one or more of the first through sixth aspects, process 800 includes transmitting an indication of the one or more coefficients for each of the one or more IoT devices.

In an eighth aspect, alone or in combination with one or more of the first through seventh aspects, a phase indication of the one or more coefficients indicates a silence duration for a silence period or a configuration for the silence period, when an amplitude indication of the one or more coefficients indicates a zero value.

In a ninth aspect, alone or in combination with one or more of the first through eighth aspects, process 800 includes transmitting an indication of a beamforming duration, in which the one or more IoT devices are to perform signal forwarding, and in which the one or more IoT devices are not to receive a command to write to the one or more IoT devices or not to transmit data that is stored by the one or more IoT devices by backscattering.

In a tenth aspect, alone or in combination with one or more of the first through ninth aspects, process 800 includes transmitting an indication of a silence duration, in which the one or more IoT devices are not to receive a command to write to the one or more IoT devices, not to transmit data that is stored by the one or more IoT devices by backscattering, or not to perform signal forwarding by beamforming.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a UE, in accordance with the present disclosure. Example process 900 is an example where the UE (e.g., UE 120) performs operations associated with signal forwarding using one or more coefficients for beamforming.

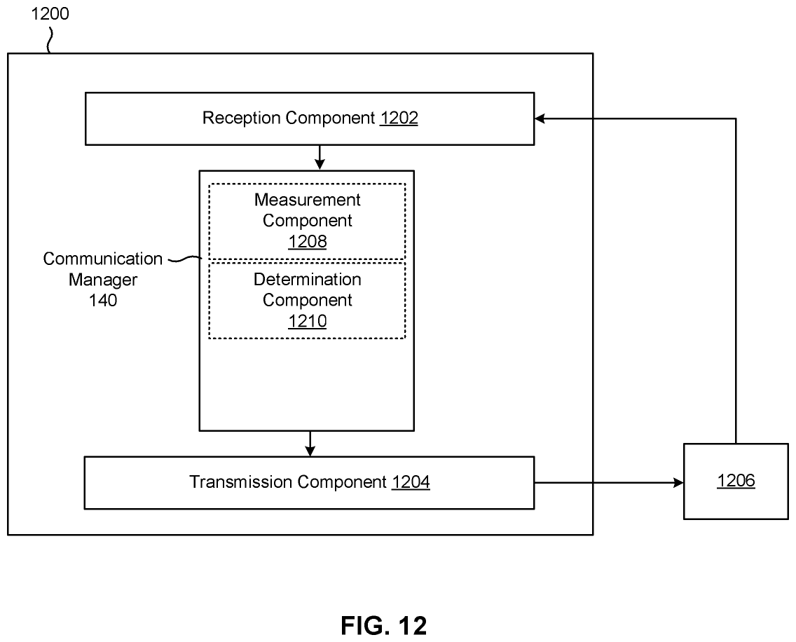

As shown in FIG. 9, in some aspects, process 900 may include receiving configuration information indicating at least one reference signal set relating to signal forwarding, by an IoT device, using one or more coefficients for beamforming (block 910). For example, the UE (e.g., using communication manager 140 and/or reception component 1202, depicted in FIG. 12) may receive configuration information indicating at least one reference signal set relating to signal forwarding, by an IoT device, using one or more coefficient for beamforming, as described above, for example, with reference to FIG. 6.

As further shown in FIG. 9, in some aspects, process 900 may include receiving reference signals of the at least one reference signal set (block 920). For example, the UE (e.g., using communication manager 140 and/or reception component 1202, depicted in FIG. 12) may receive reference signals of the at least one reference signal set, as described above, for example, with reference to FIG. 6.

Process 900 may include additional aspects, such as any single aspect or any combination of aspects described below and/or in connection with one or more other processes described elsewhere herein.

In a first aspect, process 900 includes transmitting, based at least in part on receiving the reference signals of the at least one reference signal set, information indicating the one or more coefficients that are to be used by the one or more IoT devices.

In a second aspect, alone or in combination with the first aspect, process 900 includes transmitting, based at least in part on receiving the reference signals of the at least one reference signal set, information indicating a combination of the one or more IoT devices that are to be used for signal forwarding to the UE.

In a third aspect, alone or in combination with one or more of the first and second aspects, process 900 includes transmitting, based at least in part on receiving the reference signals of the at least one reference signal set, information indicating at least one of a timing or a beamforming time offset for signal forwarding by the one or mor IoT devices to the UE.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. As described elsewhere herein, the apparatus 1000 may be an IoT device, alone or as a part of a UE, or the IoT device may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include a beamforming component 1008, among other examples.

In some aspects, the apparatus 1000 may be configured to perform one or more operations described herein in connection with FIG. 6. Additionally, or alternatively, the apparatus 1000 may be configured to perform one or more processes described herein, such as process 700 of FIG. 7, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2. In some aspects, for example, where the apparatus 1000 is not included in a UE, the reception component 1002 may not perform one or more of the signal processing functions described above and/or the reception component 1002 may not include or utilize one or more of the components described above to perform operations described herein in connection with FIGS. 6A-6G. In some aspects, for example, where the apparatus 1000 is included in a UE, the reception component 1002 may include or utilize one or more components of the UE, described above, to perform one or more of the signal processing functions described above.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver. In some aspects, for example, where the apparatus 1000 is not included in a UE, the transmission component 1004 may not perform one or more of the signal processing functions described above and/or the transmission component 1004 may not include or utilize one or more of the components described above to perform operations described herein in connection with FIGS. 6A-6G. In some aspects, for example, where the apparatus 1000 is included in a UE, the transmission component 1004 may include or utilize one or more components of the UE, described above, to perform one or more of the signal processing functions described above.

The transmission component 1004 may transmit signal forwarding capability information indicating one or more capabilities relating to signal forwarding using one or more coefficients for beamforming. The reception component 1002 and/or the transmission component 1004 may communicate in accordance with the signal forwarding capability information.

The reception component 1002 may receive an indication to activate or deactivate a power amplifier.

The reception component 1002 may receive configuration information indicating at least one reference signal set relating to signal forwarding.

The reception component 1002 may receive an indication of the one or more coefficients for at least one antenna of the apparatus 1000. The beamforming component 1008 may apply (e.g., set) the one or more coefficients to the at least one antenna.

The reception component 1002 may receive an indication of a beamforming duration.

The reception component 1002 may receive an indication of a silence duration.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150. The communication manager 150 may include a determination component 1108, among other examples.

In some aspects, the apparatus 1100 may be configured to perform one or more operations described herein in connection with FIG. 6. Additionally, or alternatively, the apparatus 1100 may be configured to perform one or more processes described herein, such as process 800 of FIG. 8, or a combination thereof. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The reception component 1102 may receive signal forwarding capability information indicating one or more capabilities of an IoT device relating to signal forwarding using one or more coefficients for beamforming. The reception component 1102 and/or the transmission component 1104 may communicate in accordance with the signal forwarding capability information.

The transmission component 1104 may transmit an indication to activate or deactivate a power amplifier.

The transmission component 1104 may transmit configuration information indicating at least one reference signal set relating to signal forwarding.

The transmission component 1104 may transmit an indication of the one or more coefficients for at least one antenna of an IoT device.

The transmission component 1104 may transmit an indication of a beamforming duration.

The transmission component 1104 may transmit an indication of a silence duration.

The determination component 1108 may determine whether an IoT device is to activate or deactivate a power amplifier, the one or more coefficients, the beamforming duration, and/or the silence duration.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a UE (e.g., RFID tag reader device), or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include one or more of a measurement component 1208 or a determination component 1210, among other examples.

In some aspects, the apparatus 1200 may be configured to perform one or more operations described herein in connection with FIG. 6. Additionally, or alternatively, the apparatus 1200 may be configured to perform one or more processes described herein, such as process 900 of FIG. 9, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The reception component 1202 may receive configuration information indicating at least one reference signal set relating to signal forwarding, by one or more IoT devices, using one or more coefficients for beamforming. The reception component 1202 may receive reference signals of the at least one reference signal set.

The transmission component 1204 may transmit, based at least in part on receiving the reference signals of the at least one reference signal set, information indicating the one or more coefficient that are to be used by the one or more IoT devices.

The transmission component 1204 may transmit, based at least in part on receiving the reference signals of the at least one reference signal set, information indicating a combination of the one or more IoT devices that are to be used for signal forwarding to the apparatus 1200.

The transmission component 1204 may transmit, based at least in part on receiving the reference signals of the at least one reference signal set, information indicating at least one of a timing or a beamforming time offset for signal forwarding by the one or more IoT devices to the apparatus 1200.

The measurement component 1208 may perform measurements of reference signals of the at least one reference signal set. The determination component 1210 may determine the one or more coefficients, the combination of the IoT devices, and/or the timing or the beamforming time offset.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by an apparatus of an Internet-of-Things (IoT) device, comprising: transmitting signal forwarding capability information indicating one or more capabilities relating to signal forwarding using one or more coefficients for beamforming; and communicating in accordance with the signal forwarding capability information.

Aspect 2: The method of Aspect 1, wherein the IoT device is a radio frequency identification (RFID) tag radio.

Aspect 3: The method of Aspect 1, wherein the IoT device is a radio frequency identification (RFID) tag radio that is part of a user equipment (UE), and wherein the UE is enabled to communicate using the RFID tag radio while the UE is in a low-power mode or based at least in part on a configuration to operate the RFID tag radio.

Aspect 4: The method of any of Aspects 1-3, wherein the one or more capabilities indicate a capability of the IoT device for power boosting.

Aspect 5: The method of any of Aspects 1-4, wherein the one or more capabilities indicate one or more power boosting states usable by the IoT device and a maximum power boosting level usable by the IoT device.

Aspect 6: The method of any of Aspects 1-5, wherein the one or more capabilities indicate at least one of an amplitude resolution usable by the IoT device or a phase resolution usable by the IoT device.

Aspect 7: The method of any of Aspects 1-6, wherein the one or more capabilities indicate a class of the IoT device that indicates at least one of: one or more power levels usable by the IoT device, an amplitude resolution usable by the IoT device, a phase resolution usable by the IoT device, or whether the IoT device has multiple antennas.

Aspect 8: The method of any of Aspects 1-7, further comprising: receiving an indication to activate or deactivate a power amplifier.

Aspect 9: The method of any of Aspects 1-8, further comprising: receiving configuration information indicating at least one reference signal set relating to signal forwarding.

Aspect 10: The method of any of Aspects 1-9, further comprising: receiving an indication of the one or more coefficients for at least one antenna of the IoT device.

Aspect 11: The method of Aspect 10, wherein a phase indication of the one or more coefficients indicates a silence duration for a silence period or a configuration for the silence period, when an amplitude indication of the one or more coefficients indicates a zero value.

Aspect 12: The method of any of Aspects 1-11, further comprising: receiving an indication of a beamforming duration, in which the IoT device is to perform signal forwarding, and in which the IoT device is not to receive a command to write to the IoT device or not to receive a request to transmit data that is stored by the IoT device by backscattering.

Aspect 13: The method of any of Aspects 1-12, further comprising: receiving an indication of a silence duration, in which the IoT device is not to receive a command to write to the IoT device, not to receive a request to transmit data that is stored by the IoT device by backscattering, or not to receive a request to perform signal forwarding by beamforming.

Aspect 14: A method of wireless communication performed by an apparatus of a network node, comprising: receiving signal forwarding capability information indicating one or more capabilities of one or more Internet-of-Things (IoT) devices relating to signal forwarding using one or more coefficients for beamforming; and communicating in accordance with the signal forwarding capability information.

Aspect 15: The method of Aspect 14, wherein the one or more capabilities indicate a capability of each of the one or more IoT devices for power boosting.

Aspect 16: The method of any of Aspects 14-15, wherein the one or more capabilities indicate one or more power boosting states usable by each of the one or more IoT devices and a maximum power boosting level usable by each of the one or more IoT devices.

Aspect 17: The method of any of Aspects 14-16, wherein the one or more capabilities indicate at least one of an amplitude resolution usable by each of the one or more IoT devices or a phase resolution usable by each of the one or more IoT devices.

Aspect 18: The method of any of Aspects 14-17, wherein the one or more capabilities indicate a class of each of the one or more IoT devices that indicates at least one of: one or more power levels usable by each of the one or more IoT devices, an amplitude resolution usable by each of the one or more IoT devices, a phase resolution usable by each of the one or more IoT devices, or whether each of the one or more IoT devices has multiple antennas.

Aspect 19: The method of any of Aspects 14-18, further comprising: transmitting an indication to activate or deactivate a power amplifier to each of the one or more IoT devices.

Aspect 20: The method of any of Aspects 14-19, further comprising: transmitting configuration information indicating at least one reference signal set relating to signal forwarding.

Aspect 21: The method of any of Aspects 14-20, further comprising: transmitting an indication of the one or more coefficients for each of the one or more IoT devices.

Aspect 22: The method of Aspect 21, wherein a phase indication of the one or more coefficients indicates a silence duration for a silence period or a configuration for the silence period, when an amplitude indication of the one or more coefficients indicates a zero value.

Aspect 23: The method of any of Aspects 14-22, further comprising: transmitting an indication of a beamforming duration, in which the one or more IoT devices are to perform signal forwarding, and in which the one or more IoT devices are not to receive a command to write to the one or more IoT devices or not to transmit data that is stored by the one or more IoT devices by backscattering.

Aspect 24: The method of any of Aspects 14-23, further comprising: transmitting an indication of a silence duration, in which the one or more IoT devices are not to receive a command to write to the one or more IoT devices, not to transmit data that is stored by the one or more IoT devices by backscattering, or not to perform signal forwarding by beamforming.

Aspect 25: A method of wireless communication performed by an apparatus of a user equipment (UE), comprising: receiving configuration information indicating at least one reference signal set relating to signal forwarding, by one or more Internet-of-Things (IoT) devices, using one or more coefficients for beamforming; and receiving reference signals of the at least one reference signal set.

Aspect 26: The method of Aspect 25, further comprising: transmitting, based at least in part on receiving the reference signals of the at least one reference signal set, information indicating the one or more coefficients that are to be used by the one or more IoT devices.

Aspect 27: The method of any of Aspects 25-26, further comprising: transmitting, based at least in part on receiving the reference signals of the at least one reference signal set, information indicating a combination of the one or more IoT devices that are to be used for signal forwarding to the UE.

Aspect 28: The method of any of Aspects 25-27, further comprising: transmitting, based at least in part on receiving the reference signals of the at least one reference signal set, information indicating at least one of a timing or a beamforming time offset for signal forwarding by the one or mor IoT devices to the UE.

Aspect 29: An apparatus for wireless communication at a device, comprising a processor; memory coupled with the processor; and instructions stored in the memory and executable by the processor to cause the apparatus to perform the method of one or more of Aspects 1-13.

Aspect 30: A device for wireless communication, comprising a memory and one or more processors coupled to the memory, the one or more processors configured to perform the method of one or more of Aspects 1-13.

Aspect 31: An apparatus for wireless communication, comprising at least one means for performing the method of one or more of Aspects 1-13.

Aspect 32: A non-transitory computer-readable medium storing code for wireless communication, the code comprising instructions executable by a processor to perform the method of one or more of Aspects 1-13.

Aspect 33: A non-transitory computer-readable medium storing a set of instructions for wireless communication, the set of instructions comprising one or more instructions that, when executed by one or more processors of a device, cause the device to perform the method of one or more of Aspects 1-13.

Aspect 34: An apparatus for wireless communication at a device, comprising a processor; memory coupled with the processor; and instructions stored in the memory and executable by the processor to cause the apparatus to perform the method of one or more of Aspects 14-24.

Aspect 35: A device for wireless communication, comprising a memory and one or more processors coupled to the memory, the one or more processors configured to perform the method of one or more of Aspects 14-24.

Aspect 36: An apparatus for wireless communication, comprising at least one means for performing the method of one or more of Aspects 14-24.

Aspect 37: A non-transitory computer-readable medium storing code for wireless communication, the code comprising instructions executable by a processor to perform the method of one or more of Aspects 14-24.

Aspect 38: A non-transitory computer-readable medium storing a set of instructions for wireless communication, the set of instructions comprising one or more instructions that, when executed by one or more processors of a device, cause the device to perform the method of one or more of Aspects 14-24.

Aspect 39: An apparatus for wireless communication at a device, comprising a processor; memory coupled with the processor; and instructions stored in the memory and executable by the processor to cause the apparatus to perform the method of one or more of Aspects 25-28.

Aspect 40: A device for wireless communication, comprising a memory and one or more processors coupled to the memory, the one or more processors configured to perform the method of one or more of Aspects 25-28.

Aspect 41: An apparatus for wireless communication, comprising at least one means for performing the method of one or more of Aspects 25-28.

Aspect 42: A non-transitory computer-readable medium storing code for wireless communication, the code comprising instructions executable by a processor to perform the method of one or more of Aspects 25-28.

Aspect 43: A non-transitory computer-readable medium storing a set of instructions for wireless communication, the set of instructions comprising one or more instructions that, when executed by one or more processors of a device, cause the device to perform the method of one or more of Aspects 25-28.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at an Internet-of-Things (IoT) device, comprising:
a memory; and
one or more processors, coupled to the memory, configured to:
transmit signal forwarding capability information indicating one or more capabilities relating to signal forwarding using one or more coefficients for beamforming; and
communicate in accordance with the signal forwarding capability information.

2. The apparatus of claim 1, wherein the IoT device is a radio frequency identification (RFID) tag radio.

3. The apparatus of claim 1, wherein the IoT device is a radio frequency identification (RFID) tag radio that is part of a user equipment (UE), and
wherein the UE is enabled to communicate using the RFID tag radio while the UE is in a low-power mode or based at least in part on a configuration to operate the RFID tag radio.

4. The apparatus of claim 1, wherein the one or more capabilities indicate a capability of the IoT device for power boosting.

5. The apparatus of claim 1, wherein the one or more capabilities indicate one or more power boosting states usable by the IoT device and a maximum power boosting level usable by the IoT device.

6. The apparatus of claim 1, wherein the one or more capabilities indicate at least one of an amplitude resolution usable by the IoT device or a phase resolution usable by the IoT device.

7. The apparatus of claim 1, wherein the one or more capabilities indicate a class of the IoT device that indicates at least one of one or more power levels usable by the IoT device, an amplitude resolution usable by the IoT device, a phase resolution usable by the IoT device, or whether the IoT device has multiple antennas.

8. The apparatus of claim 1, wherein the one or more processors are further configured to:
receive an indication to activate or deactivate a power amplifier.

9. The apparatus of claim 1, wherein the one or more processors are further configured to:
receive configuration information indicating at least one reference signal set relating to signal forwarding.

10. The apparatus of claim 1, wherein the one or more processors are further configured to:
receive an indication of the one or more coefficients for at least one antenna of the IoT device.

11. The apparatus of claim 10, wherein a phase indication of the one or more coefficients indicates a silence duration for a silence period or a configuration for the silence period, when an amplitude indication of the one or more coefficients indicates a zero value.

12. The apparatus of claim 1, wherein the one or more processors are further configured to:
receive an indication of a beamforming duration, in which the IoT device is to perform signal forwarding, and in which the IoT device is not to receive a command to write to the IoT device or not to receive a request to transmit data that is stored by the IoT device by backscattering.

13. The apparatus of claim 1, wherein the one or more processors are further configured to:
receive an indication of a silence duration, in which the IoT device is not to receive a command to write to the IoT device, not to receive a request to transmit data that is stored by the IoT device by backscattering, or not to receive a request to perform signal forwarding by beamforming.

14. An apparatus for wireless communication at a network node, comprising:
a memory; and
one or more processors, coupled to the memory, configured to:
receive signal forwarding capability information indicating one or more capabilities of one or more Internet-of-Things (IoT) devices relating to signal forwarding using one or more coefficients for beamforming; and
communicate in accordance with the signal forwarding capability information.

15. The apparatus of claim 14, wherein the one or more capabilities indicate a capability of each of the one or more IoT devices for power boosting.

16. The apparatus of claim 14, wherein the one or more capabilities indicate one or more power boosting states usable by each of the one or more IoT devices and a maximum power boosting level usable by each of the one or more IoT devices.

17. The apparatus of claim 14, wherein the one or more capabilities indicate at least one of an amplitude resolution usable by each of the one or more IoT devices or a phase resolution usable by each of the one or more IoT devices.

18. The apparatus of claim 14, wherein the one or more capabilities indicate a class of each of the one or more IoT devices that indicates at least one of: one or more power levels usable by each of the one or more IoT devices, an amplitude resolution usable by each of the one or more IoT devices, a phase resolution usable by each of the one or more IoT devices, or whether each of the one or more IoT devices has multiple antennas.

19. The apparatus of claim 14, wherein the one or more processors are further configured to:
transmit an indication to activate or deactivate a power amplifier to each of the one or more IoT devices.

20. The apparatus of claim 14, wherein the one or more processors are further configured to:
transmit configuration information indicating at least one reference signal set relating to signal forwarding.

21. The apparatus of claim 14, wherein the one or more processors are further configured to:
transmit an indication of the one or more coefficients for each of the one or more IoT devices.

22. The apparatus of claim 21, wherein a phase indication of the one or more coefficients indicates a silence duration for a silence period or a configuration for the silence period, when an amplitude indication of the one or more coefficients indicates a zero value.

23. The apparatus of claim 14, wherein the one or more processors are further configured to:
transmit an indication of a beamforming duration, in which the one or more IoT devices are to perform signal forwarding, and in which the one or more IoT devices are not to receive a command to write to the one or more IoT devices or not to transmit data that is stored by the one or more IoT devices by backscattering.

24. The apparatus of claim 14, wherein the one or more processors are further configured to:
transmit an indication of a silence duration, in which the one or more IoT devices are not to receive a command to write to the one or more IoT devices, not to transmit data that is stored by the one or more IoT devices by backscattering, or not to perform signal forwarding by beamforming.

25. An apparatus for wireless communication at a user equipment (UE), comprising:
a memory; and
one or more processors, coupled to the memory, configured to:
receive configuration information indicating at least one reference signal set relating to signal forwarding, by one or more Internet-of-Things (IoT) devices, using one or more coefficients for beamforming; and
receive reference signals of the at least one reference signal set.

26. The apparatus of claim 25, wherein the one or more processors are further configured to:
transmit, based at least in part on receiving the reference signals of the at least one reference signal set, information indicating the one or more coefficients that are to be used by the one or more IoT devices.

27. The apparatus of claim 25, wherein the one or more processors are further configured to:
transmit, based at least in part on receiving the reference signals of the at least one reference signal set, information indicating a combination of the one or more IoT devices that are to be used for signal forwarding to the UE.

28. The apparatus of claim 25, wherein the one or more processors are further configured to:
transmit, based at least in part on receiving the reference signals of the at least one reference signal set, information indicating at least one of a timing or a beamforming time offset for signal forwarding by the one or mor IoT devices to the UE.

29. A method of wireless communication performed by an Internet-of-Things (IoT) device, comprising:
transmitting signal forwarding capability information indicating one or more capabilities relating to signal forwarding using one or more coefficients for beamforming; and
communicating in accordance with the signal forwarding capability information.

30. The method of claim 29, wherein the one or more capabilities indicate a capability of the IoT device for power boosting.
